(19) United States
(12) Patent Application Publication
(10) Pub. No.: US 2011/0307095 A1
(43) Pub. Date: Dec. 15, 2011

(54) Method for Processing Flat Products and Corresponding Device

(75) Inventor: Michel Chretinat, Agnetz (FR)

(73) Assignee: GOSS INTERNATIONAL MONTATAIRE SA, Montataire (FR)

(21) Appl. No.: 13/159,198

(22) Filed: Jun. 13, 2011

(30) Foreign Application Priority Data
Jun. 11, 2010 (FR) 10 54655

(51) Int. Cl. G06F 17/00; B07C 5/00; G06F 19/00; B65G 57/00

(52) U.S. Cl. 700/217; 700/214; 702/81

(57) ABSTRACT

A method for processing a plurality of flat printed products is provided. The method includes the steps of determining one of at least two quality statuses for each flat printed product and for each flat printed product, storing a first information representing the determined quality status and a second information combining the first information with said flat printed product. The invention also relates to a corresponding device for processing flat printed products.

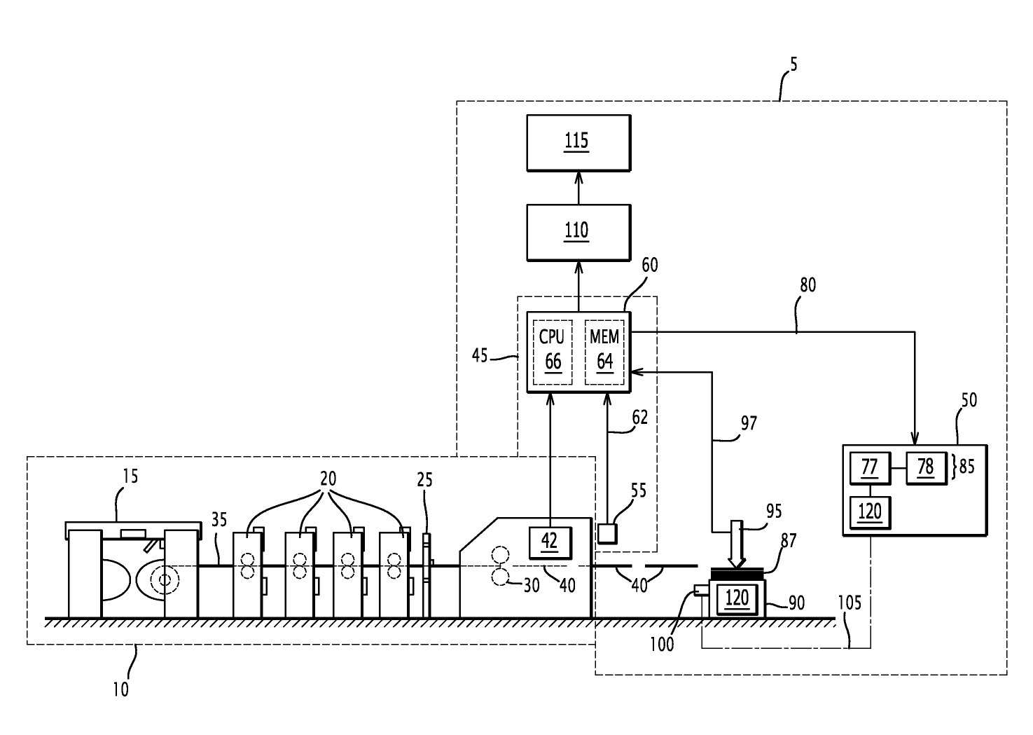

Priority is hereby claimed to FR 10 54655 field on Jun. 11, 2010, the entire disclosure of which is hereby incorporated by reference herein.

The present invention relates to a method for processing a plurality of flat printed products.

### BACKGROUND OF THE INVENTION

Known from the state of the art is a method in which an operator successively inspects the finished products, such as sections of a newspaper, printed using a printing press. The printed products that the operator considers to be of poor quality may be ejected and directed towards a bad copy outlet. The good copies are conveyed and stacked. The ejection is sometimes not very reliable and the possibility of the stack of good copies actually including bad ones as well cannot be dismissed.

As a result, an unknown number of good quality printed products is combined with poor quality products and it is difficult to assess whether the production has already reached the necessary number of good quality copies.

Another problem resulting from the prior art method is that the reliability of the inspection of the printed products depends on the operator and it is not guaranteed that all of the printed products stacked on the final pile will meet the quality requirements. This is all the more crucial when the production speed is high.

In this way, the growth of the printing speed led to the design of printing presses that print on a substrate band that is successively cut into sheets. These sheets are then stacked at the outlet of the press. The speed of these printing presses is high enough that it is not feasible to direct the poor copies upstream of the press outlet.

### BRIEF SUMMARY OF THE INVENTION

The present invention provides a method for processing flat printed products that allows them to be sorted effectively according to their quality.

The present invention provides a method comprising the following steps of, for each flat printed product, determining one of at least two quality statuses, and for each flat printed product, storing a first information representing the determined quality status and a second information combining the first information with said flat printed product.

According to other preferred embodiments, the method may include one or more of the following features:
each flat printed product is a printed sheet;
the flat printed products are printed sections of a continuous band, in particular each section including the image of a page;
storing the first information and the second information in one or more storage means or a storage device;
stacking the flat printed products, without taking the first information into account, forming one or more piles;
the number of flat printed products stacked on each pile is measured continuously based on the height and/or weight of the stacked flat printed products;
the number of stacked flat printed products is counted continuously using a counter arranged upstream of each pile;
the step of stacking the flat printed products comprises stacking the flat products on at least one support, in particular a pallet;
the first information and the second information are grouped together per pile by forming a group of information and the or each pile is associated with the corresponding group of information;
the or each group of information is stored on a computer medium arranged on the support holding the pile with which the computer medium is associated;
for the or each pile and for the associated group of information, a reference information is created associating the group of information and the pile, and the reference information is stored together with the group of information as well as with the pile;
sorting stacked flat printed products according to the first information;
the quality status is determined using an inspection device comprising a detection device adapted to detect at least one feature of each flat printed product and a management device adapted to compare the at least one detected feature with a predetermined standard and to generate the first information based on the comparison;
the inspection device also comprises at least one totalizer, each totalizer being adapted to count, as a function of the first information representing a quality status, the number of flat printed products.

The present invention also provides a device for processing flat printed products comprising an inspection device adapted to determine, for each flat printed product, one of at least two quality statuses, and one or more storage means or devices adapted to store, for each flat printed product, a first information representing the determined quality status and a second information associating the first information with the flat printed product, the processing device being adapted to implement a method as defined above.

### BRIEF DESCRIPTION OF THE DRAWING

The invention will be better understood upon reading the following description, provided solely as an example and done in reference to the appended drawing, in which the sole FIGURE is a diagrammatic view of a processing device according to the invention arranged at the outlet of a printing press with a cutter.

### DETAILED DESCRIPTION

The FIGURE shows a device for processing flat printed products, designated by general reference 5. This processing device 5 is arranged at the outlet of a printing press 10.

The printing press 10 successively comprises an unwinder 15, four printing units 20, a traction device 25, and a cutting device 30. Nevertheless, the number of printing units 20 is not limited to four. The printing press 10 can comprise any number of printing units 20. The unwinder 15 is adapted to unwind a continuous web or band 35 to be printed on which the printing units 20 print an image repeatedly. The traction device 25 is adapted to apply a predetermined mechanical tension on the continuous band 35 coming out of the printing unit 20 which is arranged the furthest downstream. The cutting device 30 is adapted to cut the continuous band 35 into a plurality of flat printed products 40. Each flat printed product 40 is for example a printed sheet or a printed section of the continuous band 35, each sheet and/or each section including the image of a page. A printing press of the aforementioned type is for example disclosed by French patent FR 2888527.

The printing press 10 can also comprise a counter 42. The number of flat printed products 40 leaving the printing press 10 is counted by the counter 42.

The processing device 5 comprises an inspection device 45 and one or more storage means or storage devices 50.

The inspection device 45 comprises a detection device 55 and a management device 60.

The detection device 55 is adapted to detect, for each flat printed product 40, at least one printing quality feature. The detection device 55 is for example a CCD camera that generates an image showing the at least one printing quality feature. The at least one print quality feature is for example the superposition or the relative position of several print layers applied on the flat printed products 40. Alternatively, one print quality feature is the optical density of the printed image. Also alternatively, the quality feature is the characteristic of the sheet (good/bad sheet).

The management device 60 is connected to the detection device 55 using a first data line 62. Information representing the at least one print quality feature is transmitted from the detection device 55 to the management device 60 via this first data line 62.

The management device 60 comprises a memory 64 and a processor 66. The processor 66 is adapted to compare the information representing each print quality characteristic detected for each flat printed product 40 by the detection device 55 to a corresponding standard defined for each of the at least one feature, in order to evaluate the print quality of each flat printed product 40. As a function of this comparison, the management device 60 attributes the print quality of each flat printed product 40 to one among at least two quality statuses. The processor 66 generates, for each flat printed product 40, a first information 77 representing the determined quality status. The processor 66 also generates, for each flat printed product 40, a second information 78 that associates the first information with the flat printed product 40 for which the first information 77 has been created. The second information 78 is for example a serial number of the associated flat printed product 40 or can be the location of the first information 77 in the storage device 50.

Alternatively, the inspection device 45 can be replaced by the operator himself.

The or each corresponding standard is stored for the or each print quality characteristic, for example in the memory 64 of the management device 60. If applicable, the or each standard can be stored elsewhere than in the memory 64 of the management device 60, for example in an external memory.

The storage device 50 is connected to the management device 60 of the inspection device 45 using a second data line 80. The second data line 80 is adapted to transmit information, such as the aforementioned first information 77 and second information 78, from the management device 60 to the storage device 50 and/or from the storage device 50 to the management device 60.

The storage device 50 is adapted to store, for each flat printed product 40, the first information 77. The storage device 50 is also adapted to store, for each flat printed product 40, the second information 78 that associates the first information 77 with the flat printed product 40 for which the first information 77 was created. The first information 77 and second information 78 of a plurality of flat printed products 40 can be grouped together so as to form one or more groups of information 85 for the corresponding plurality of flat printed products 40.

After passage near the detection device 55, the flat printed products 40 are stacked, independently of the first information 77, forming one or more piles 87.

The processing device 5 also comprises at least one support 90 and at least one measuring means or measuring device 95.

The or each support 90 is adapted to receive the flat printed products 40 and to support the pile 87 thus formed. Preferably, a support 90 supports a single pile 87 of flat printed products 40. The support 90 is for example a pallet. The aforementioned groups of information 85 can be formed so that for each pile 87 or support 90, a group of information 85 is created.

The or each measuring device 95 is adapted to determine, continuously or at predetermined intervals, the number of flat printed products 40 stacked on a pile 87 supported by a support 90. Preferably, an individual measuring device 95 is associated with each support 90. That means, preferably, one individual measuring device 95 is associated with each pile 87. Such a determination of the number of stacked flat printed products 40 is done in that the or each measuring device 95 measures the height of the pile 87 and/or the weight of the pile 87. In both cases, an individual calibration of the measuring device 95 is necessary for each production. Preferably, the calibration is done using a curve relating several values for the number of stacked flat printed products 40 with the weight or height of the corresponding piles 87.

The or each measuring device 95 is also adapted to detect whether part of the stacked flat printed products 40 is taken from the pile 87, for example by a user. Based on the weight and/or height difference due to the withdrawal of flat printed products 40 and based on the calibration, the measuring device 95 determines the number of flat printed products 40 that have been taken from the pile 87.

The or each measuring device 95 is connected using a third data line 97 to the management device 60. The third data line 97 is adapted to transmit, continuously or at a predetermined interval, information representing the number of flat printed products 40 stacked on a pile 87 determined using the respective measuring device 95.

Alternatively, the determination of the number of flat printed products 40 stacked on each pile 87 can be done by synchronizing the counter 42 of the printing press 10 with the management device 60, the counter 42 being arranged upstream of each pile 87.

The processing device 5 also comprises at least one computer medium 100. The or each computer medium 100 is adapted to store information. The computer medium 100 is for example a RFID label. Preferably, one computer medium 100 is associated with one support 90. The computer medium 100 is for example fastened on the corresponding support 90. The information stored by the computer medium 100 are for example the first information 77 and the second information 78 grouped together in information groups 85, for the flat printed products 40 stacked on the associated support 90. In this case, the computer medium 100 stores the same group of information 85 as the storage means 50. This is shown in the FIGURE by a broken line 105. The computer medium 100 and the storage device 50 can coexist, in order to store each group of information 85 locally and centrally, respectively. Alternatively, the computer media 100 of all of the supports 90 can replace the storage device 50 that stores the groups of information 85 for all of the piles 87 supported by all of the supports 90.

In one embodiment, the management device 60 combined with the detection device 55 serves as a totalizer adapted to count the flat printed products 40 as a function of the first information 77. That means, in the event the first information 77 represents at least two quality statuses, this totalizer is adapted to individually count the number of flat printed products 40 for each quality status.

Alternatively, the processing device 5 can comprise one or more additional individual totalizers 110.

Also alternatively, the processing device 5 is adapted to provide a report 115. The report 115 is a summary of information for a production comprising direct information such as, for example:
the total number of flat printed products 40,
the total number of flat printed products 40 for each quality status,
for each pile 87, the number of flat printed products 40 for each quality status,
the first information 77 and second information 78 for each pile 87,
   and indirect information, such as statistical information, which result from the direct information.

The processing device 5 described above is adapted to implement a method for processing a plurality of flat printed products 40 as follows.

The flat printed products 40 leave the printing press 10 on a conveyor conveying them towards the support 90 on which the flat printed products 40 are stacked. During transportation between the printing press 10 and the stacking support 90, each flat printed product 40 passes the detection device 55, which detects, for each flat printed product 40, the at least one print quality characteristic, and which creates an information representing the at least one detected feature.

One example is the case where a single print quality characteristic is detected for each flat printed product 40.

The information representing the detected characteristic is transferred using the first data line 62 to the management device 60, which compares the information representing the detected characteristic to the corresponding standard and, based on that comparison, assigns the detected characteristic unequivocally to one of the at least two predefined quality statuses. In this way, the management device 60 generates the first information 77 representing the quality status determined by the management device 60. The first information 77 representing the determined quality status is then stored in the storage device 50. The second information 78 associating the first information 77 with the flat printed product 40 for which the first information 77 was created is also generated by the management device 60 and stored together with the first information 77 in the storage device 50.

Then, the flat printed products 40 are stacked on one or more piles 87, independently of the first information 77. The total number of flat printed products 40 of each pile 87 is measured continuously or at predetermined intervals, either by the device 95 for height- and/or weight-based measurement of the stacked flat printed products 40, or by synchronizing the counter 42 of the printing press 10 with the management device 60

Using the management device 60, the first information 77 and second information 78 for all of the flat printed products 40 stacked on the same pile 87 are grouped together for each pile 87 forming the group of information 85 for each pile 87. Each group of information 85 is stored in the storage device 50.

In the case of several piles 87, it is necessary to be able to identify, for each pile 87, the group of information 85 with which the pile 87 is associated and which is stored together with the groups of information 85 of the other piles 87 in the storage device 50 using an identification method.

According to a first embodiment of this identification method, the management device 60 generates, for each pair [pile 87—group of information 85], a reference information 120 that is stored on the one hand with the pile 87 and on the other hand with the group of information 85 stored for the corresponding pile 87 in the storage means 50. Each pile 87 and each group of information 85 can therefore be identified by the reference information 120 attributed to them. The reference information 120 is for example a bar code.

According to a second embodiment of the identification method, the group of information 85 is stored on the computer medium 100 arranged on the support 90 supporting the pile 87 associated with the group of information 85. In this case, each pile 87 is associated with a computer medium 100. Thus, the group of information 85 stored locally with the pile 87 with which the group of information 85 is associated.

Also alternatively, the first embodiment of the identification method based on the reference information 120 and the second embodiment of the method based on the computer medium 100 can be combined, for example for security reasons.

In the event the measuring device 95 detects that part of the flat printed products 40 is withdrawn from the pile 87, an information representing the number of withdrawn flat printed products 40 is sent to the management device 60 using the third data line 97. The first information 77 and second information 78 associated with the withdrawn flat printed products 40 are thus removed from the group of information 85 associated with the pile 87 from which the flat printed products 40 are removed. As a result, the withdrawal of flat printed products 40 does not create an inconsistency between the group of information 85 and the related pile 87.

The processing method according to the invention is adapted to know, at all times during production, the total number of flat printed products 40 and the number of flat printed products 40 belonging to one or each quality status. Moreover, it is possible to know, at any time during production, for each pile 87, the number of flat printed products 40 belonging to one or each quality status. This information can be summarized in a report 115 accessible for a user.

For example, two quality statuses exist, in particular “good” and “bad,” meaning that the quality of the flat printed product 40 meets or does not meet, respectively, predefined quality criteria. The production of flat printed products 40 can be stopped when the total number of products 40 having “good” status is reached. Relative to the processing methods of the prior art, it is not necessary to over estimate or overdimension production to ensure that the number of products 40 having the “good” status is actually reached. This represents savings in terms of production time and production cost.

Based on the identification methods described above, it is possible to know, for each flat printed product 40 in each pile 87, the quality status. This information is useful for example to sort the stacked flat printed products 40, the sorting depending on the first information 77, in particular according to their quality status. The sorting step can comprise a step for separating the flat printed products 40 with “good” status from flat printed products 40 with “bad” status. The flat printed products 40 with “good” status are then used for the continuation of the production.

Since the processing method according to the invention is adapted to accurately identify the products 40 with “bad” status, it is possible to eliminate only the products 40 with “bad” status from production and to keep all products 40 with “good” status. This again represents savings in terms of production cost and decreases the discard rate.

Furthermore, the processing method and the processing device 5 according to the invention guarantee an objective quality assessment, i.e. completely identical, for each flat printed product 40 all throughout production.

1.-15. (canceled)

16. A method for processing a plurality of flat printed products comprising the steps of:
determining one of at least two quality statuses for each flat printed product, and
storing a first information representing the determined quality status and a second information combining the first information with each flat printed product.

17. The method according to claim 16, wherein each flat printed product is a printed sheet.

18. The method according to claim 16, wherein the flat printed products are printed sections of a continuous web, each section including an image of a page.

19. The method according to claim 16, further comprising storing the first information and second information in one or more storage devices.

20. The method according to claim 16, further comprising stacking the flat printed products without taking the first information into account and forming one or more piles.

21. The method according to claim 20, wherein the number of flat printed products stacked on each pile is measured continuously based on the height or weight of the stacked flat printed products.

22. The method according to claim 20, wherein the number of stacked flat printed products is counted continuously using a counter arranged upstream of each pile.

23. The method according to claim 20, wherein the step of stacking the flat printed products includes stacking the flat products on at least one support.

24. The method according to claims 20, wherein the first information and the second information are grouped together per pile by forming a group of information and the or each pile being associated with the corresponding group of information.

25. The method according to claim 23, wherein the first information and the second information are grouped together per pile by forming a group of information and the or each pile being associated with the corresponding group of information, the or each group of information being stored on a computer medium arranged on the support holding the pile with which the computer medium is associated.

26. The method according to claim 24, wherein for the or each pile and for the associated group of information, a reference information is created associating the group of information and the pile, and the reference information is stored together with the group of information as well as with the pile.

27. The method according to claim 20, further comprising sorting stacked flat printed products according to the first information.

28. The method according claim 16, wherein the quality status is determined using an inspection device that includes a detection device adapted to detect at least one feature of each flat printed product and a management device adapted to compare the at least one detected feature with a predetermined standard and to generate the first information based on the comparison.

29. The method according to claim 28, wherein the inspection device includes at least one totalizer, each totalizer counting, as a function of the first information representing a quality status, the number of flat printed products.

30. A device for processing flat printed products, comprising:
an inspection device adapted to determine, for each flat printed product, one of at least two quality statuses, and
one or more storage devices adapted to store, for each flat printed product, a first information representing the determined quality status and a second information associating the first information with the flat printed product,
the device determining one of at least two quality statuses for each flat printed product and storing a first information representing the determined quality status and a second information combining the first information with each flat printed product.

31. The method according to claim 23 wherein the support is a pallet.
